(19) United States
(12) Patent Application Publication
(10) Pub. No.: US 2012/0169604 A1
(43) Pub. Date: Jul. 5, 2012

(54) METHOD FOR PREVENTING MIS-TOUCH OF A TOUCH KEYBOARD AND TOUCH CONTROL ELECTRICAL APPARATUS

(76) Inventors: Ta-Chang Chen, Taipei City (TW); Mu-Te Chien, Taipei City (TW); Chun-Yin Wu, Taipei City (TW); Chen-Yi Wang, Taipei City (TW); Chi-Hsin Lin, Taipei City (TW); Shi-Kuan Chen, Taipei City (TW)

(21) Appl. No.: 13/340,266

(22) Filed: Dec. 29, 2011

Related U.S. Application Data
(60) Provisional application No. 61/429,190, filed on Jan. 3, 2011.

(51) Int. Cl. G06F 3/023

(52) U.S. Cl. 345/168

(57) ABSTRACT

A method for preventing mis-touch of a touch keyboard includes triggering a timer when the touch keyboard is touched. A key code corresponding to the touched position is obtained and stored in a storage unit. When the touched position discontinues being touched, the timer is stopped and a touched time of the touch keyboard is obtained from the timer. The touched time is compared with a touched-time upper bound. If the touched time is less than the touched-time upper bound, the stored key code is output.

### CROSS-REFERENCE TO RELATED APPLICATION

This application claims the priority benefit of U.S. Provisional Application Ser. No. 61/429,190, filed Jan. 3, 2011, the full disclosures of which are incorporated herein by reference.

### BACKGROUND

1. Technical Field

The present invention relates to a method for preventing mis-touch of a touch keyboard and a touch control electrical apparatus applying the method.

2. Description of Related Art

With technological progress, various different electrical apparatuses have been developed. For example, desktop computers, laptop computers, and mobile phones have become a part of most people's lives.

Users typically operate electrical apparatuses through input units. The most common input units of computer mice and keyboards move cursors or input data to operate electrical apparatuses.

Traditional keyboards may be classified as mechanical-switch keyboards or membrane keyboards. A user must press a key on such a traditional keyboard by more than a pre-set distance to input a character. Hence, a user can put his/her fingers slightly on such traditional keyboards without causing any character input, such as when he/she wants to take a break.

Lately, more and more electrical apparatuses are equipped with touch screens which are used as input units for such apparatuses. Touch screens sense user touch to generate corresponding input characters. Hence, once a user's hand or finger touches such a touch screen, a corresponding input character may be generated. This may lead to mis-touch when the user inadvertently touches the touch screen, or touches the touch screen without the intent to input a character. Hence, if a user wants to take a break, he/she must take his/her hand or finger away from such touch screens, and this is different from the way the user may be accustomed to using a keyboard.

### SUMMARY

According to one embodiment of this invention, a method for preventing mis-touch of a touch keyboard is provided. In the method for preventing mis-touch of a touch keyboard, when the touch keyboard is touched at a touched position, a timer is triggered. At least one key code corresponding to the at least one touched position is obtained and stored in a storage unit. When the touched position discontinues being touched, the timer is stopped and a touched time is obtained from the timer corresponding to the duration during which the touched position was touched. The touched time is compared with a touched-time upper bound. If the touched time is less than the touched-time upper bound, the stored key code is output.

According to another embodiment of this invention, a touch control electrical apparatus is provided. The touch control electrical apparatus includes a touch keyboard, a timer, a storage unit, a processing unit and an embedded controller (EC). The EC is electrically connected with the touch keyboard, the timer, the storage unit and the processing unit. The EC includes a triggering module, an obtaining module, a stopping module, a comparing module and an output module. The triggering module detects if the touch keyboard is touched at a touched position. When it is detected that the touch keyboard is touched at the touched position, the triggering module triggers the timer. The obtaining module obtains a key code corresponding to the touched position, and stores the key code in the storage unit. When the touched position discontinues being touched, the stopping module stops the timer and obtains a touched time from the timer corresponding to the duration during which the touched position was touched. The comparing module compares the touched time with a touched-time upper bound. If the touched time is less than the touched-time upper bound, the output module outputs the stored key code to the processing unit for processing.

According to still another embodiment of this invention, a method for preventing mis-touch of a touch keyboard is provided. In the method, detection is performed to determine if the touch keyboard is touched at a touched position. When the touch keyboard is touched at the touched position, a timer is triggered. A key code corresponding to the touched position is obtained and stored in a storage unit. When the timer has been triggered for more than a time threshold without stopping, a determination is made as to whether the key code stored in the storage unit corresponds to a preset position of the touch keyboard is determined. When the key code stored in the storage unit does not correspond to the preset position, the key code stored in the storage unit is output. When the key code stored in the storage unit corresponds to the preset position, the stored key code is not output.

The present invention can achieve many advantages. If a user mis-touches several keys not belonging to any key combination, the corresponding key code is not output. Furthermore, the touch keyboard can be divided into several sub-regions. If a user mis-touches one such sensing area, only the mis-touched sensing area may be locked and key codes in the locked area are not output. As a result, mis-touches in the locked area can be avoided and other areas can still be utilized for input. In addition, the computation resource for repeatedly determining mis-touch in the same locked sensing area can be saved. Moreover, a preset position of the touch keyboard can be provided for users to place their fingers on for rest without causing a mis-touch. In one embodiment of this invention, the position corresponding to ‘f’ and/or ‘j’ can be assigned as the preset position, which can give users an experience similar to traditional keyboards.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a flow diagram of a method for preventing mis-touch of a touch keyboard according to one embodiment of this invention;

FIG. 2 is a flow diagram of a method for preventing mis-touch of a touch keyboard according to another embodiment of this invention;

FIG. 3 is a flow diagram of a method for preventing mis-touch of a touch keyboard according to another embodiment of this invention;

FIG. 4 is a flow diagram of a method for preventing mis-touch of a touch keyboard according to another embodiment of this invention; and

FIG. 5 illustrates a block diagram of a touch control electrical apparatus according to an embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

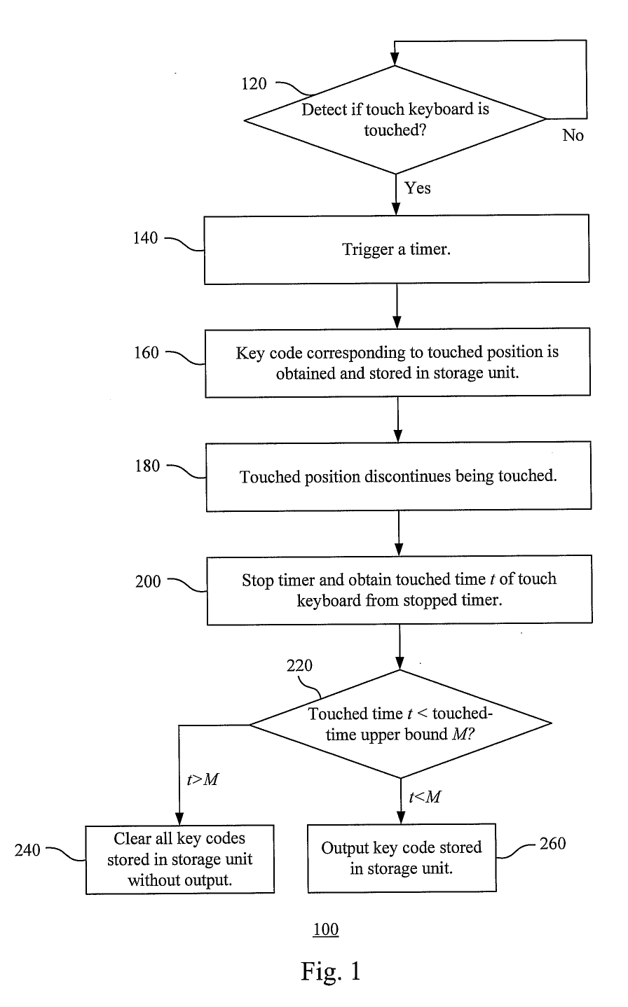

Referring to FIG. 1, a flow diagram will be described that illustrates a method for preventing mis-touch of a touch keyboard according to one embodiment of this invention. The method for preventing mis-touch of a touch keyboard may take the form of a computer program product stored on a computer-readable storage medium having computer-readable instructions embodied in the medium. Any suitable storage medium may be used. In some embodiments, such suitable storage medium may be a non-transitory computer readable storage medium including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives. In other embodiments, other suitable storage mediums may be used, which should not be limited in this disclosure.

The routine 100 of the method for preventing mis-touch of a touch keyboard may begin at operation 120, where detection is performed to detect if the touch keyboard is touched. If no touch is detected on the touch keyboard, the routine 100 may return back to operation 120.

When the touch keyboard is touched, the routine 100 continues from operation 120 to operation 140 to trigger a timer to start counting.

The routine 100 then continues to operation 160, where a key code corresponding to the touched position is obtained and stored in a storage unit. The key code may be a touched position of the touch keyboard, a touched coordinate of the touch keyboard or any other type of key code. The storage unit may be a flash memory, a hard disk, a register, a cache or any other type of storage unit.

When the touched position discontinues being touched at operation 180, the routine 100 subsequently continues to operation 200 to stop counting of the timer and to obtain a touched time t of the touch keyboard from the stopped timer. In other words, in one scenario of this invention, if a user removes one of his/her fingers from the touch keyboard, the touch keyboard may sense that the user has stopped touching the touched position and the counting of the timer is stopped (operation 200). In other scenarios of this invention, a user may operate the touch keyboard in other ways and the touch keyboard may sense the discontinuing of touches in different ways, which should not be limited in this disclosure.

The routine 100 continues from operation 200 to operation 220, where a determination is made as to whether the touched time t is less than a touched-time upper bound M.

If the touched time t is less than the touched-time upper bound M, the routine 100 continues to operation 260 to output the key code obtained and stored at operation 160. In one embodiment of this invention, the key code stored in the storage unit may be directly output at operation 260. Hence, the key code may be converted into a scan code.

At operation 220, if the touched time t is not less than the touched-time upper bound M (i.e., the touch time is greater than the touched-time upper bound M), this indicates that the touched position corresponds to a mis-touch, and as a result, the routine 100 branches to operation 240 to clear all key codes stored in the storage unit without output. Therefore, touching of the touch keyboard for a sufficiently long time is interpreted as a mis-touch. Hence, input resulting from such a mis-touch is not performed.

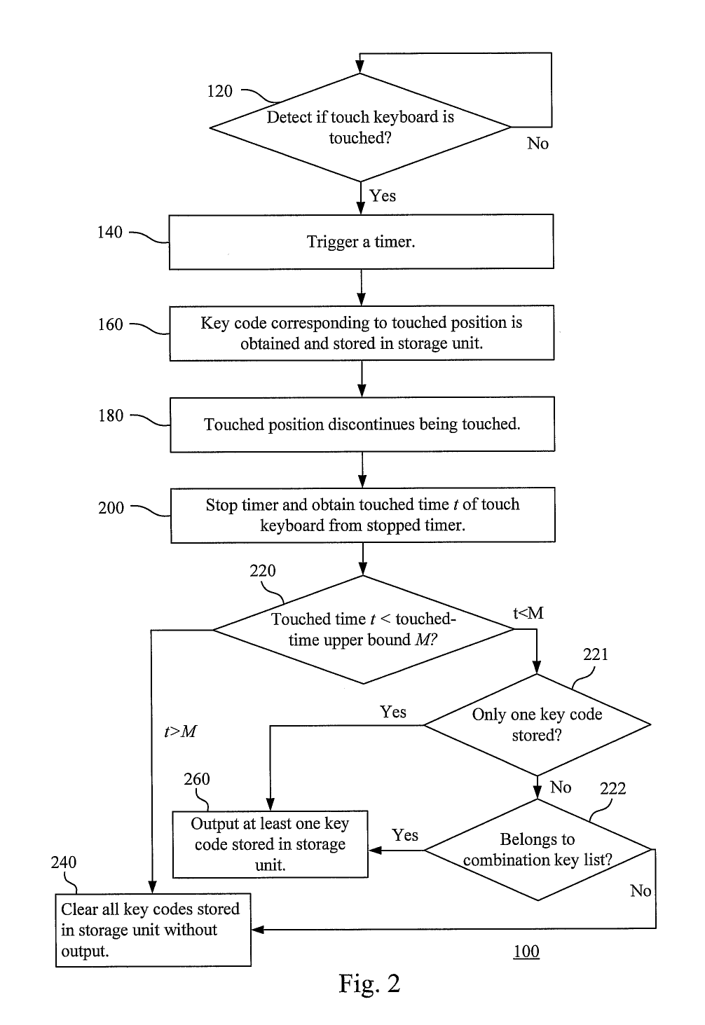

Moreover, a user may touch several keys at the same when he/she wants to input a combination key. In most instances, touching several keys at the same time is due to mis-touch. However, if the touched keys can form a combination key, the touched keys will be interpreted as such and not as a mis-touch. Referring to FIG. 2, a flow diagram will be described that illustrates a method for preventing mis-touch of a touch keyboard according to another embodiment of this invention. It is to be understood that aspects of this embodiment similar to those described with reference to FIG. 1 may not be repeated.

At operation 220, if the touched time t for each of the touched positions is less than the touched-time upper bound M, the routine 100 may continue to operation 221 to determine if only one key code is stored in the storage unit. In some embodiments, operation 221 may involve determining if the number of the key codes stored in the storage unit is more than one, which should not be limited in this disclosure.

If only one key code is stored in the storage unit, the routine 100 may continue to operation 260 to directly output the only one stored key code. If the number of the key codes stored in the storage unit is more than one, the routine 100 may continue to operation 222 to determine if the key codes stored in the storage unit belong to a combination key list. In some embodiments, operation 222 may involve a determination of whether the key codes stored in the storage unit can form any key combination in the combination key list. The combination key list may include key combinations of hot keys, key combinations which form words or any other type of key combinations.

Subsequently, if the key codes stored in the storage unit belong to the combination key list, the routine 100 may continue to operation 260 to output the key codes stored in the storage unit. Therefore, even if a user inputs several keys to form a key combination, this may not be interpreted as a mis-touch.

If all of the key codes stored in the storage unit do not belong to the combination key list, the routine 100 may continue to operation 240 to clear all the key codes stored in the storage unit without output. Therefore, if a user mis-touches several keys not belonging to any key combination, a key code is not output.

In addition, the touch keyboard may be divided into several sub-regions. When a user touches several keys in the same sensing area, resulting in the key codes stored in the storage unit not belonging to the combination key list, the method of this invention may further lock the sensing area of the touch keyboard corresponding to the touched keys. Subsequently, keys in the locked sensing area are not output by subsequent touch actions. Other sub-regions that are not locked may still be utilized for input. Hence, the touch keyboard may include several sub-regions, and the routine 100 may further include an operation to lock the sub-regions corresponding to the key codes stored in the storage unit when all key codes stored in the storage unit do not belong to the combination key list. Therefore, mis-touch in the same sensing area of the touch keyboard can be avoided. In addition, the computation resource for repeatedly determining mis-touch in the same locked sensing area can be saved.

Furthermore, the routine 100 may further determine if a user touches several sub-regions for use as the factor for locking areas. Hence, the routine 100 may further include an operation, where when the number of the at least one key code stored in the storage unit is more than one and none of them belongs to the combination key list, determining if the key codes stored in the storage unit belong to the same sensing area of the touch keyboard. If the key codes stored in the storage unit belong to the same sensing area, the sensing area corresponding to the stored key codes is locked without outputting the key codes. Therefore, each mis-touched sensing area of the touch keyboard can be locked separately, and a user can still perform input through other sub-regions of the touch keyboard.

In some embodiments, a specific position of the touch keyboard can be assigned for users to put their fingers on without output of the corresponding key code. Hence, the routine 100 may further include an operation, where before outputting the at least one key code stored in the storage unit, determining if the at least one key code stored in the storage unit corresponds to a preset position of the touch keyboard. In some embodiments, a position of a positioning key (for example, ‘f’ and/or ‘k’ key) may be assigned as the preset position. In other embodiments, any other position can be assigned as the preset position of the touch keyboard, which should not be limited in this disclosure. If the at least one key code stored in the storage unit corresponds to the preset position, all key codes stored in the storage unit are cleared without being output. Therefore, the preset position can be provided to users to put their fingers on for rest without causing a mis-touch. In one embodiment of this invention, the position corresponding to ‘f’ and/or ‘j’ can be assigned as the preset position, which can give users an experience similar to traditional keyboards.

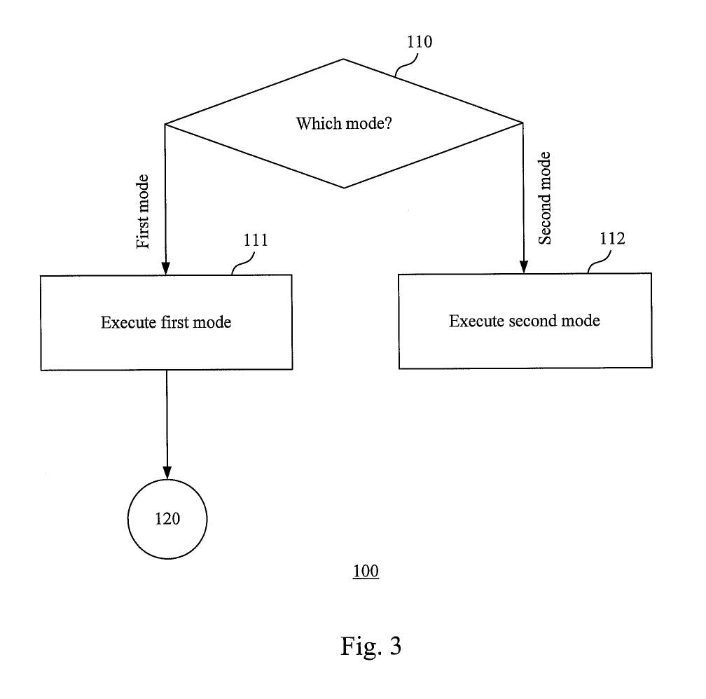

Moreover, the method for preventing mis-touch of a touch keyboard may provide several modes. Referring to FIG. 3, a flow diagram will be described that illustrates a method for preventing mis-touch of a touch keyboard according to another embodiment of this invention. The routine 100 may start at operation 110 to determine which mode has been selected. If it is determined that the first mode is selected, the routine 100 may continue to operation 111, where the touch keyboard executes the first mode and continues detection at operation 120. If it is determined that the second mode is selected, the routine 100 may continue to operation 112, where the touch keyboard executes the second mode.

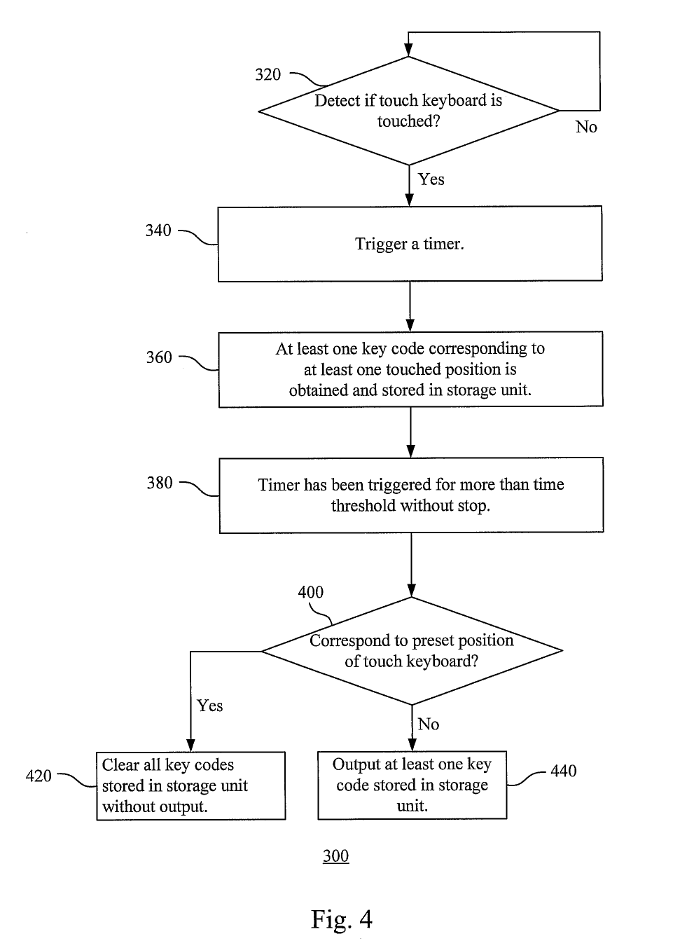

Referring to FIG. 4, a flow diagram will be described that illustrates a method for preventing mis-touch of a touch keyboard according to another embodiment of this invention. In this embodiment, when the touch keyboard executes the second mode at operation 112, a routine 300 of the method for preventing mis-touch of a touch keyboard may be performed.

The routine 300 may start at operation 320, where detection is performed to determine if the touch keyboard is touched. If no touch is detected on the touch keyboard, the routine returns back to operation 320.

When at least one position of the touch keyboard is touched, the routine 300 continues to operation 340, where a timer is triggered to start counting.

The routine 300 then continues to operation 360, where at least one key code corresponding to the at least one touched position is obtained and stored in a storage unit.

When the timer has been triggered to perform counting for more than a time threshold without stopping (operation 380), the routine 300 continues to operation 400 to determine if at least one key code stored in the storage unit corresponds to a preset position of the touch keyboard. In some embodiments, the timer may be triggered to count down from the value of the time threshold, and when the timer counts down to zero, it is determined that the timer has been triggered to count for more than the time threshold without stopping (operation 380).

When the at least one key code stored in the storage unit corresponds to the preset position, the routine 300 continues to operation 420 to clear all key codes stored in the storage unit without output. Therefore, the preset position can be provided to users to put their fingers on for rest without resulting in a mis-touch.

When the at least one key code stored in the storage unit does not correspond to the preset position, the routine 300 continues to operation 440 to output the at least one key code stored in the storage unit. In other embodiments, the routine 300 can be performed independently without performing the routine 100, which should not be limited in this disclosure.

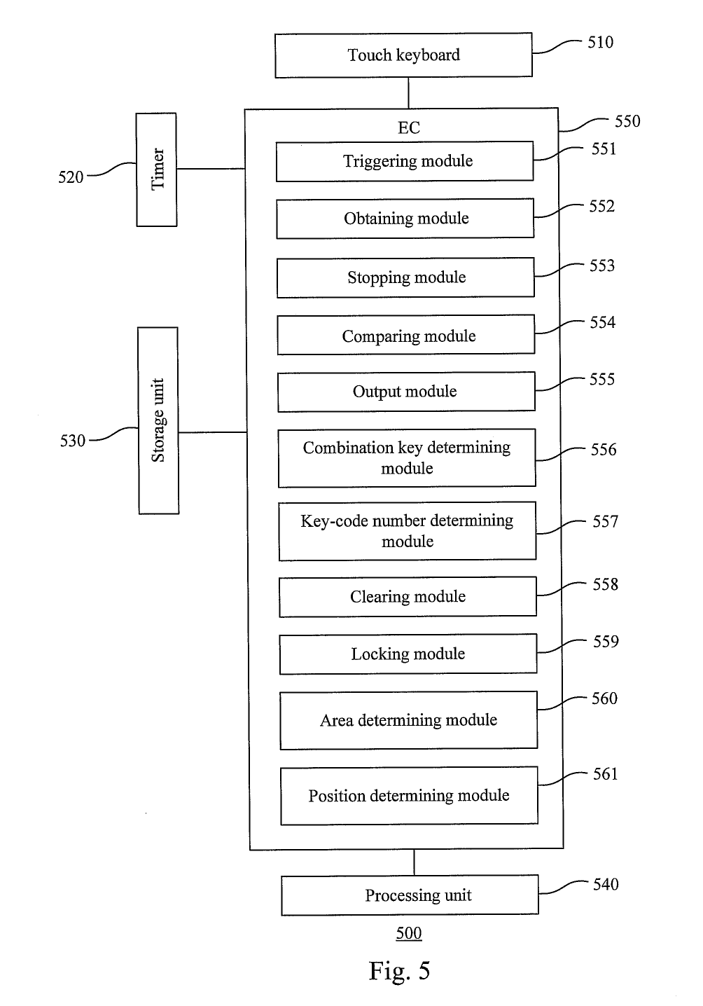

Referring to FIG. 5, a block diagram will be described that illustrates a touch control electrical apparatus according to an embodiment of this invention.

The touch control electrical apparatus 500 includes a touch keyboard 510, a timer 520, a storage unit 530, a processing unit 540 and an embedded controller (EC) 550. The EC 550 is electrically connected with the touch keyboard 510, the timer 520, the storage unit 530 and the processing unit 540. In one embodiment, the EC 550 may be electrically connected with the processing unit 540 through a South Bridge (SB) chip (not shown). In other embodiments, the EC 550 may be electrically connected with the processing unit 540 utilizing other methods, which should not be limited in this disclosure. The storage unit 530 may be a flash memory, a hard disk, a register, a cache or any other type of storage unit. The EC 550 may be a keyboard controller (KBC) or any other type of EC.

The EC 550 includes a triggering module 551, an obtaining module 552, a stopping module 553, a comparing module 554 and an output module 555. The triggering module 551 detects if the touch keyboard 510 is touched. When it is detected that the touch keyboard 510 is touched, the triggering module 510 triggers the timer 520 to count.

The obtaining module 552 obtains a key code corresponding to the touched position of the touch keyboard 510. The corresponding key code may be a touched position of the touch keyboard 510, a touched coordinate of the touch keyboard 510 or any other type of key code. Subsequently, the obtaining module 552 stores the key code in the storage unit 530. When the touched position of the touch keyboard 510 discontinues being touched, the stopping module 553 stops the counting of the timer 520 and obtains a touched time of the touch keyboard 510 from the stopped timer 520. In one scenario of this invention, if a user removes one of his/her fingers from the touch keyboard 510, the touch keyboard 510 may sense that the touched position is no longer being touched and the counting of the timer 520 may be stopped. In other scenarios of this invention, a user may operate the touch keyboard 510 in other ways and the touch keyboard 510 may sense discontinuation of touch in different ways, which should not be limited in this disclosure.

The comparing module 554 compares the touched time with a touched-time upper bound. If the touched time is less than the touched-time upper bound, the output module 555 outputs the key code stored in the storage unit 530 to the processing unit 540 for processing. In one embodiment of this invention, the key code stored in the storage unit 530 may be output to the processing unit 540 directly. Hence, in some embodiments, the processing unit 540 may take the key code as the code received from a physical keyboard and do further processing. In some other embodiments, the processing unit may take the key code as the code received from any other type of input unit and do corresponding processing, which should not be limited in this disclosure.

In some embodiments, the EC may further include a clearing module 558. When the touched time is more than the touched-time upper bound, the clearing module 558 clears all key codes stored in the storage unit 530 without output. Therefore, touching for a sufficiently long time may be interpreted as a mis-touch, thereby preventing input due to mis-touch in this type of scenario.

Moreover, a user may touch several keys at the same when he/she wants to input a combination key. In most instances, touching several keys at the same time is due to mis-touch. However, the EC may further include a combination key determining module 556 and a key-code number determining module 557. Before outputting the key codes corresponding to the touched keys stored in the storage unit 530, the combination key determining module 556 determines if the key codes stored in the storage unit 530 belong to the combination key list. In some embodiments, the combination key determining module 556 may determine if the key codes stored in the storage unit 530 can form any key combination in the combination key list. The combination key list may include key combinations of hot keys, key combinations which form words or any other type of key combinations.

The key-code number determining module 557 determines if the number of the key codes stored in the storage unit 557 is more than one. When the number of the key codes stored in the storage unit 557 is more than one and the key codes stored in the storage unit 530 belong to the combination key list, the output module 555 outputs the combination key code corresponding to the stored key codes to the processing unit 540 for processing. Therefore, a user can input a key combination formed by several keys, and this may not be interpreted as a mis-touch.

In addition, if all of the key codes stored in the storage unit 530 do not belong to the combination key list, the EC 550 clears all the key codes stored in the storage unit 530 without output. Therefore, if a user mis-touches several keys not belonging to any key combination, a key code is not output.

In addition, when a user touches several keys not belonging to the combination key list, sub-regions of the touch keyboard 510 corresponding to the touched key codes may be locked. Subsequently, keys in the locked sensing area are not output by subsequent touch actions. Other sub-regions of the touch keyboard 510 that are not locked may still be utilized for input. Hence, the touch keyboard 510 may include several sub-regions. The EC 550 may further include a locking module 559. The locking module 559 determines if any of the key codes stored in the storage unit 530 belong to the combination key list. When all key codes stored in the storage unit 530 do not belong to the combination key list, the locking module 559 locks the sub-regions of the touch keyboard 510 corresponding to the key codes stored in the storage unit 530 without output. Therefore, mis-touch in the sensing area of the touch keyboard 510 can be avoided, thereby preventing continued mis-touch in the same area. In addition, the computation resource for repeatedly determining mis-touch in the same locked sensing area can be saved.

Furthermore, the touch control electrical apparatus 500 may further determine if a user mis-touches several sub-regions of the touch keyboard 510 for use as the factor for locking several areas. Hence, the EC 550 may further include an area determining module 560. When number of the at least one key code stored in the storage unit 530 is more than one and none of these keys belong to the combination key list, the area determining module 560 determines if the key codes stored in storage unit 530 belong to the same sensing area. When the key codes stored in storage unit 530 belong to the same sensing area, the locking module locks this sensing area of the touch keyboard 510. Therefore, mis-touched sub-regions of the touch keyboard 510 can be locked, which can prevent mis-touches in the same area.

In some embodiments, a specific position of the touch keyboard 510 can be assigned for users to put their fingers on without output of the corresponding key code. Hence, the EC may further include a position determining module 561. The position determining module 561 determines if the at least one key code stored in the storage unit 530 corresponds to a preset position of the touch keyboard 510. In some embodiments, a position of a positioning key (for example, ‘f’ and/or ‘k’ key) of the touch keyboard 510 may be assigned as the preset position. In other embodiments, any other position can be assigned as the preset position of the touch keyboard 510, which should not be limited in this disclosure. When the at least one key code stored in the storage unit 530 corresponds to the preset position, the output module 561 does not output the at least one key code stored in the storage unit 530. Therefore, the preset position can be provided to users to put their fingers on for rest without causing a mis-touch. In one embodiment of this invention, the position of the touch keyboard 510 corresponding to ‘f’ and/or can be assigned as the preset position, which can give users an experience similar to traditional keyboards.

In addition, the touch control electrical apparatus 500 may determine whether to output or not after the timer 520 has been triggered for more than a time threshold without stopping. In some embodiments of this invention, if the timer 520 has been triggered for more than a time threshold without stopping, the position determining module 561 determines if the at least one key code stored in the storage unit 530 corresponds to a preset position of the touch keyboard 510.

When the at least one key code stored in the storage unit 530 does not correspond to the preset position, the output module 530 outputs the at least one key code stored in the storage unit 540 to the processing unit for processing. Hence, at least one key code stored in the storage unit 530 may be output at regular intervals.

Moreover, when the at least one key code stored in the storage unit 530 corresponds to the preset position, the output module 555 does not output the at least one key code stored in the storage unit 530, and the clearing module 558 clears all key codes in the storage unit 530. Therefore, the preset position can be provided to users to put their fingers on for rest without causing a mis-touch.

The present invention can achieve many advantages. If a user inputs several keys to form a key combination, this is not interpreted as a mis-touch. In addition, if a user mis-touches several keys not belonging to any key combination, the corresponding key code is not output. Furthermore, the touch keyboard can be divided into several sub-regions. If a user mis-touches one such sensing area, only the mis-touched sensing area may be locked and key codes in the locked area are not output. As a result, mis-touches in the locked area can be avoided and other areas can still be utilized for input. In addition, the computation resource for repeatedly determining mis-touch in the same locked sensing area can be saved. Moreover, a preset position of the touch keyboard can be provided for users to place their fingers on for rest without a mis-touch. In one embodiment of this invention, the position corresponding to ‘f’ and/or ‘j’ can be assigned as the preset position, which can give users an experience similar to traditional keyboards.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for preventing mis-touch of a touch keyboard comprising:
detecting if the touch keyboard is touched at a touched position;
when the touch keyboard is touched at the touched position, triggering a timer;
obtaining at least one key code corresponding to the touched position, and storing the key code in a storage unit;
when the touched position discontinues being touched, stopping the timer and obtaining a touched time from the timer corresponding to the duration during which the touched position was touched;
comparing the touched time with a touched-time upper bound; and
if the touched time is less than the touched-time upper bound and there only one key code stored in the storage unit or there are a plurality of key codes stored in the storage unit and a least one of the plurality key codes belongs to a combination key list, outputting the one or the plurality of stored key codes.

2. The method for preventing mis-touch of a touch keyboard of claim 1 further comprising:
if the touched time is greater than the touched-time upper bound, clearing the stored key code in the storage unit.

3. The method for preventing mis-touch of a touch keyboard of claim 1, wherein the touch keyboard comprises a plurality of sub-regions, and the method for preventing mis-touch of a touch keyboard further comprises:
determining whether at least one of the plurality of key codes in the storage unit belongs to a combination key list; and
if none of the plurality of key codes in the storage unit belongs to a combination key list, locking the sub-regions corresponding to the plurality of key codes stored in the storage unit.

4. The method for preventing mis-touch of a touch keyboard of claim 1, wherein before outputting the key code stored in the storage unit, the method for preventing mis-touch of a touch keyboard further comprises:
determining if the one or the plurality of key codes stored in the storage unit correspond to a preset position of the touch keyboard;
wherein the one or the plurality of key codes are not output if the one or the plurality of key codes -correspond to the preset positions.

5. The method for preventing mis-touch of a touch keyboard of claim 1 further comprising:
if the timer has been triggered for more than a time threshold without stopping, determining if the key code stored in the storage unit corresponds to a preset position of the touch keyboard;
wherein the stored key code is output only if the key code stored in the storage unit does not correspond to the preset position.

6. A touch control electrical apparatus comprising:
a touch keyboard;
a timer;
a storage unit;
a processing unit; and
an embedded controller (EC) electrically connected with the touch keyboard, the timer, the storage unit and the processing unit, wherein the EC comprises:
a triggering module for detecting if the touch keyboard is touched at a touched position, and for triggering the timer when it is detected that the touch keyboard is touched at the touched position;
an obtaining module for obtaining a key code corresponding to the touched position, and storing the key code in the storage unit;
a stopping module for stopping the timer and obtaining a touched time corresponding to the duration during which the touched position was touched when the touched position discontinues being touched;
a comparing module for comparing the touched time with a touched-time upper bound; and
an output module, wherein if the touched time is less than the touched-time upper bound and there is only one key code stored in the storage unit or there are a plurality of key codes stored in the storage unit and at least one of the plurality key codes belongs to a combination key list, the output module outputs the one or the plurality of stored key codes to the processing unit for processing.

7. The touch control electrical apparatus of claim 6, wherein the EC further comprises:
a key-code number determining module for determining if the one or the plurality of key codes stored in the storage unit are plural ; and
a combination key determining module for determining whether at least one of the key codes stored in the storage unit—belongs to a combination key list when there are the plurality of key codes stored in the storage unit,
wherein, when at least one of the key codes stored in the storage unit—belongs to the combination key list, the output module outputs all of the key codes to the processing unit for processing,
wherein, the EC further comprises a clearing module, wherein when none of the key codes stored in the storage unit belongs to a combination key list, the clearing module clears all of the key codes stored in the storage unit.

8. The touch control electrical apparatus of claim 6, wherein the EC further comprises:
a clearing module for clearing the key code stored in the storage unit when the touched time is greater than the touched-time upper bound.

9. The touch control electrical apparatus of claim 6, wherein:
the touch keyboard comprises a plurality of sub-regions, the EC further comprises:
a key-code number determining module for detecting if the touch keyboard is touched at a plurality of touched positions;
a combination key determining module for determining whether at least one of the key codes stored in the storage unit -belongs to a combination key list; and
a locking module, wherein if none of the key codes stored in the storage unit belongs to a combination key list, the locking module locks—the sub-region corresponding to the key codes stored in the storage unit.

10. The touch control electrical apparatus of claim 6, wherein the touch keyboard comprises a plurality of sub-regions, the EC further comprises:
a key-code number determining module for determining if the one or the plurality of key codes stored in the storage unit are plural;-;
a combination key determining module for determining whether at least one of the key codes stored in the storage unit belongs to the combination key list;
an area determining module, wherein when none of the key codes stored in the storage unit belongs to the combination key list, the area determining module determines if the plurality of key codes stored in storage unit belong to a same sub-region; and
a locking module for locking the same sub-region of the touch keyboard corresponding to the plurality of key codes when the plurality of key codes stored in storage unit belong to the same sub-region.

11. The touch control electrical apparatus of claim 6, wherein the EC further comprises:
a position determining module for determining if the key code stored in the storage unit corresponds to a preset position of the touch keyboard, wherein the output module outputs the stored key code only when the key code stored in the storage unit corresponds to the preset position.

12. The touch control electrical apparatus of claim 7, wherein the EC further comprises:
a position determining module for determining if the key code stored in the storage unit corresponds to a preset position of the touch keyboard if the timer has been triggered for more than a time threshold without stopping,
wherein the output module outputs the stored key only when the key code stored in the storage unit does not correspond to the preset position.

13. A method for preventing mis-touch of a touch keyboard comprising:
detecting if the touch keyboard is touched at a touched position;
when the touch keyboard is touched at the touched position, triggering a timer;
obtaining one or a plurality of key codes corresponding to the touched position, and storing the one or plurality of key codes in a storage unit;
when the timer has been triggered for more than a time threshold without stopping, determining if the one or the plurality of key codes stored in the storage unit corresponds to a preset position of the touch keyboard;
if none of the one or the plurality of the key codes stored in the storage unit corresponds to the preset position, outputting the key code stored in the storage unit.
